(19) United States
(12) Patent Application Publication
(10) Pub. No.: US 2011/0181853 A1
(43) Pub. Date: Jul. 28, 2011

(54) IMAGE RECORDNG DEVICE AND IMAGE PROCESSING DEVICE

(75) Inventor: Masaaki ORIMOTO, Saitama-shi (JP)

(73) Assignee: FUJIFILM CORPORATION, Tokyo (JP)

(21) Appl. No.: 12/981,707

(22) Filed: Dec. 30, 2010

(30) Foreign Application Priority Data
Jan. 28, 2010 (JP) 2010-017078

(51) Int. Cl. G03B 27/00

(52) U.S. Cl. 355/33

(57) ABSTRACT

Present invention provides a three dimensional print with a favorable three-dimensional effect across the whole image surface at a determined view position. A face of a person or the main object within a multi-view image is extracted and the position of the extracted face is made to be the standard position to match the alignment of the lens pitch of the lenticular sheet with the alignment of the print pitch. A print position displacement amount δ is calculated based on the standard position and the print pitch. The lens position at the leftmost side with respect to the print area of the lenticular sheet 12 is detected, and printing initiates from a position displaced only with the print position displacement amount δ with respect to the detected lens position. And then, the area to the sequential right side is printed with the print pitch z.

### BACKGROUND OF THE INVENTION

1. Field of the Invention

The present invention relates to an image processing device and an image processing method, and more particularly to an image recording technology to obtain a three-dimensional print with a favorable three-dimensional effect across the whole area of an image surface.

2. Description of the Related Art

Three-dimensional photographic print three-dimensionally viewing multi-viewpoint images is known art, whereby each viewpoint image of the multi-viewpoint images are divided into striped images where these striped images are repeatedly arranged in horizontal rows in viewpoint-order to view the arranged striped images via a lenticular lens.

In the three-dimensional photographic print as mentioned above, striped images requires to be aligned appropriately with respect to the alignment of the lenticular lens.

To satisfy such requirement, JP1996-137034A (JP H08-137034A) discloses an inkjet recording device in which the relative position of the lenticular lens and its corresponding image are detected with the image printed on the rear side surface (rear surface) with respect to the surface in which a plurality of lenticular lenses are arranged, and matches the positioning of the lenticular lens with the image based on the detected results.

According to the inkjet recording device described in JP1996-137034A, the pitch misalignment between the lenticular lens and the image can be eliminated, thereby enabling the record of the image with the center of the lenticular lens and the multi-viewpoint image being matched.

However, with the large lenticular sheet, suitable three-dimensional view of the multi-viewpoint image will becomes more difficult as it approaches to the edge of the sheet when the center of the lenticular lens matches the center of the multi-viewpoint image. Therefore, at the near part of the center of the lenticular sheet, the image requires to be placed near the center of the lenticular lens, and at the near part of the edge of the lenticular sheet, the image requires to be displaced or misaligned against the center of the lenticular lens.

To satisfy those requirements, JP2000-292871A discloses a recording device that directly records an image to the rear surface of a lens sheet of a lenticular lens sheet, and moves with the image being enlarged for 1.5 to 2.0 μm per each lens towards the edge of the lens sheet from the center.

According to the recording device disclosed in JP2000-292871A, a parallax from any viewing position of eyes can be guaranteed for all the lenses even for the large lens sheet thereby enabling a high-quality three-dimensional vision for the entire lens sheet.

### SUMMARY OF THE INVENTION

Depending upon the object and the composition of the multi-viewpoint images, there is a possibility of three-dimensionally viewing with the viewer being in a viewing position not near the center of the sheet but in the different viewing position with respect to the center of the sheet.

However, for the recording device disclosed in JP2000-292871A, there is a problem that the observer can not suitably view in three-dimension since the device presupposes the three-dimensional viewing to be performed in the viewing position near the center of the lenticular lens sheet.

The present invention has been made in view of the above-mentioned problems and an object of the invention is to provide an image recording device, an image processing device, and an image processing method capable of obtaining a three-dimensional print having a favorable three-dimensional effect across the whole area of the image surface by determining viewing position based on an image information of a multi-viewpoint image.

In order to achieve above-mentioned object, according to a first aspect of the invention, there is provided an image recording device such that divided images of each viewpoint generated from multi-viewpoint images are sequentially arranged correspondingly to each lens of a lenticular sheet and the multi-viewpoint images are recorded to a recording medium to enable three-dimensional view through the lenticular sheet, wherein the device comprising, a printing pitch calculating part that calculates a printing pitch of the divided image based on the lens pitch of the lenticular sheet, a standard position determining part that determines a standard position by matching the lens pitch alignment and the printing pitch alignment based on an image information of the multi-viewpoint image, a recording position determining part that determines a recording position of each divided image based on the standard position and the printing pitch; and a recording part that records each divided image to the recording position.

According to the first aspect of the invention, since the standard position is determined by matching the lens pitch alignment and the printing pitch alignment based on the image information of the multi-viewpoint image, the standard position can be in the suitable position based on the image information of the multi-viewpoint image. As a result, a three-dimensional print that has a favorable three-dimensional effect across the whole image surface from the standard position can be obtained.

Further, in the image recording device according to the first aspect of the invention, it is preferred that the printing pitch calculating part calculates the printing pitch based on the focal length of the lens of the lenticular sheet and a preset three-dimensional vision viewing distance.

Therefore, a suitable printing pitch can be determined in such configuration as mentioned-above.

Yet further, in the image recording device according to the first aspect of the invention, it is preferred that the device being provided with a part for detecting the lens pitch of the lenticular sheet.

Therefore, even if there is a production tolerance or the like, a three dimension print with a suitable three-dimensional effect can be obtained.

Yet further, in the image recording device according to the first aspect of the invention, it is preferred that the recording part being provided with a recording head that records an image to the recording medium, and a conveyor part that relatively moves the recording head and the recording medium; and the conveyor part that relatively moves the recording head and the recording medium according to the recording position.

In such configuration, images can be recorded more appropriately in a suitable printing pitch.

Yet further, in the image recording device according to the first aspect of the invention, it is preferred that the device being provided with a main object detecting part that detects the main object of the multi-viewpoint image, and the standard position determining part determines the standard position based on the position of the main object.

In such configuration, the standard position can be determined more appropriately.

Yet further, in the image recording device according to the first aspect of the invention, it is preferred that the main object detecting part detects a person within the multi-viewpoint image to be the main object.

In this matter, the standard position can be determined more appropriately.

Moreover, in such configuration, in the image recording device according to the first aspect of the invention, it is preferred that the main object detecting part detects the face of the person within the multi-viewpoint image to be the main object.

In such configuration, the standard position can be determined more appropriately.

Yet further, in the image recording device according to the first aspect of the invention, it is preferred that the main object detecting part detects the object having large parallax in the multi-viewpoint image to be the main object.

In such configuration, the standard position can be determined more appropriately.

Yet further, in the image recording device according to the first aspect of the invention, it is preferred that the main object detecting part detects the main object according to the composition of the multi-viewpoint image.

In such configuration, the standard position can be determined more appropriately.

Moreover, in order to achieve the aforementioned object, a second aspect of the present invention is an an image processing device such that a divided image of each viewpoint generated from a multi-viewpoint image is sequentially arranged correspondingly to each lens of a lenticular sheet, wherein the device including a printing pitch calculating process that calculates a printing pitch of the divided image based on the lens pitch of the lenticular sheet, a standard position determining process that determines a standard position by matching the lens pitch alignment and the printing pitch alignment based on an image information of the multi-viewpoint image, a recording position determining process that determines a recording position of each divided image based on the standard position and the printing pitch, and an output process that outputs the recording position.

Moreover, in order to achieve the aforementioned object, a third aspect of the present invention is an image processing method with a process such that a divided image of each viewpoint generated from a multi-viewpoint image is sequentially arranged correspondingly to each lens of a lenticular sheet, wherein the method comprising a calculating process that calculates a printing pitch of the divided image based on the lens pitch of the lenticular sheet, a standard position determining process that determines a standard position by matching the lens pitch alignment and the printing pitch alignment process based on an image information of the multi-viewpoint image, a recording position determining process that determines a recording position of each divided image based on the standard position and the printing pitch, and an output process that outputs the recording position.

According to the present invention, a three dimensional print can be obtained that has a favorable three-dimensional effect across the entire image surface.

### BRIEF DESCRIPTION OF THE DRAWINGS

FIG. 1 is a enlarged view of a lenticular sheet.

FIG. 2 is an top view illustrating the lens position and printing position of a lenticular sheet.

FIG. 3 is a lateral view illustrating the lens position and printing position of a lenticular sheet.

FIG. 4 is an internal transparental view of a print device.

FIG. 5 is an internal transparental view of a print device.

FIG. 6 is a perspective view of a sheet storing part.

FIG. 7 is a perspective view of a sheet feed cassette.

FIG. 8 is a perspective view of a sheet feed cassette.

FIG. 9 is a lateral schematic view of a sheet storing part.

FIG. 10 is a diagram for explaining the sheet feed from the sheet storing part.

FIG. 11 is a diagram for explaining the sheet feed from the sheet storing part.

FIG. 12 is a diagram for explaining the sheet feed from the sheet storing part.

FIG. 13 is a plain view illustrating the schematic configuration of the clamper and the clamper conveyor part.

FIG. 14 is a drawing illustrating the positional relationship between a photo sensor, an LED and a lenticular sheet.

FIG. 15 is a schematic view of the ribbon exchange guttering structure.

FIG. 16 is a block diagram illustrating the essential configuration of a print device.

FIG. 17 is a flowchart illustrating the process operation at the time of printing by a print device.

FIG. 18 is a diagram illustrating the generation of a divided image from each multi-viewpoint image.

### DESCRIPTION OF THE PREFERRED EMBODIMENTS

The embodiment for carrying out the print device that relates to the present invention will be described hereinafter with reference to the attached drawings.

### [Calculation Process of the Printing Position of the Multi-viewpoint Image]

A description will be given initially of a suitable printing position of a multi-viewpoint image printed on a lenticular sheet.

A lenticular sheet 12 is a printing medium made of a flexible material with thermal resistance suitable for the printing operation of a thermal head 260. Materials used therein may be a transparent resin such as polycarbonate, PET (polyethylene terephthalate), PMMA (polymethyl methacrylate), or the like. Further, although the thickness of the lenticular sheet 12 is discretionary, it may be, for example, 0.3 mm in thickness.

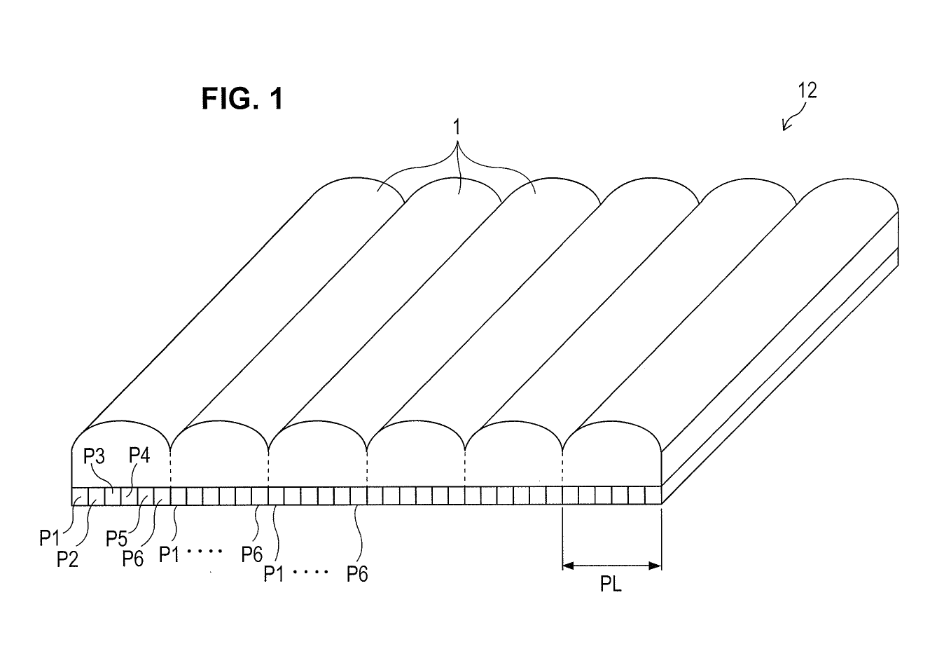

As shown in FIG. 1, a lenticular lens is formed on the lenticular sheet 12 in which the lens 1 is one-dimensionally arrayed on the surface of one side in the lens pitch PL. Further, the surface of the opposite side is a flat surface wherein no lens is formed. The multi-viewpoint image (6 viewpoints in the drawing) is printed on the flat surface along the longitudinal direction of lens 1.

In other words, processing, such as vertically thinning out pixels according to the number of viewpoints, is performed to generate a striped divided image which is vertically divided from each viewpoint image of the multi-viewpoint image, to only the number of lens 1 in the printing area of the respective lenticular sheet 12. The striped divided images are distributed respectively to each corresponding lens 1, and further, and are printed with the divided images of each viewpoint distributed to each lens 1 arranged to align in order according to the viewpoint position.

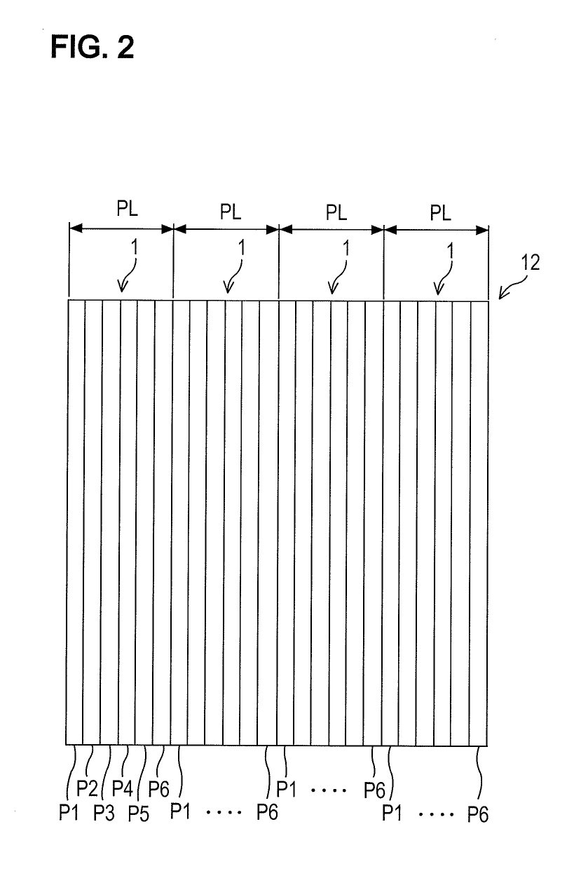

FIG. 2 is a drawing viewing the lenticular sheet 12 from above, and is a depiction illustrating an example of printing the divided images P1˜P6 generated from each viewpoint image of the 6 viewpoint images in order of P1, P2, P3, . . . , P6 corresponding to each lens 1.

Lens 1 has a lens effect in only the array direction without having a lens effect to the longitudinal direction. According to this one dimensional lens effect, only the divided image corresponding to the visual direction from among each divided images P1˜P6 arranged to correspond to each lens 1 is magnified in the array direction (lateral direction of the divided images) of the lens 1 to reach the right eye of the viewer, while in the same manner, only a different divided images are magnified in the lateral direction to reach the left eye of the viewer.

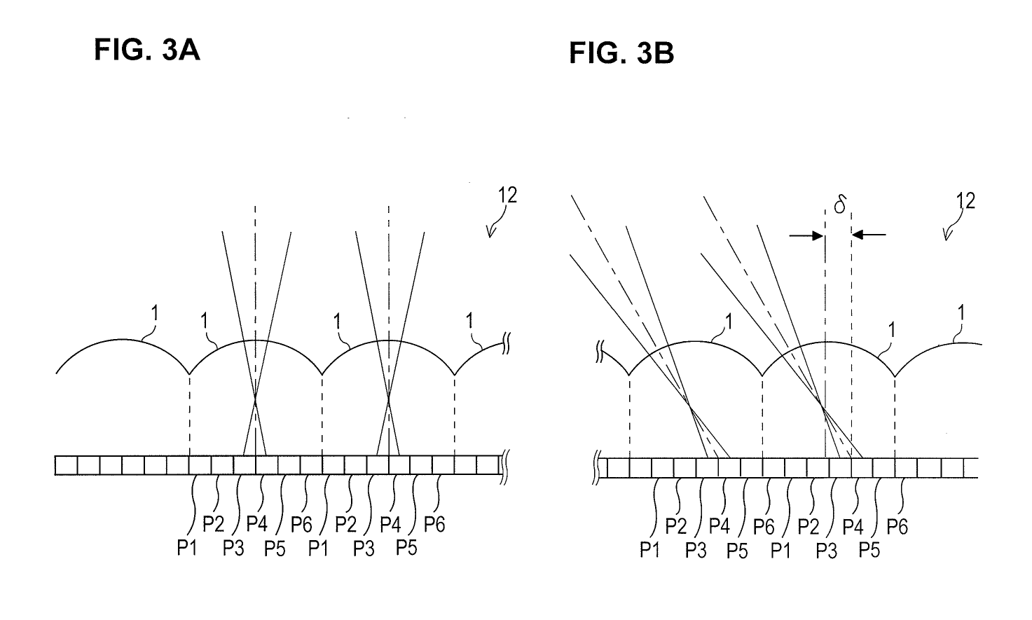

Accordingly, the viewer can see with the right eye one viewpoint image from among the multi-viewpoint image while seeing another viewpoint image with the left eye. The viewer, with the parallax of the viewpoint image seen by the left and right eyes, can view a three-dimensional image. FIG. 3 is a drawing showing an example in which the divided image P3 and P4 of the center viewpoint of the 6 viewpoint images reaching the left and right eyes.

Moreover, as shown in FIG. 3A, three-dimensional view is enabled for a viewer of an image at a position in which the lenticular sheet 12 is seen orthogonally from the position of the viewer's eye (view position) when printed so that the center of lens 1 and the center viewpoint for the divided image P3 and P4 switching point (hereinafter referred to as “center viewpoint”) match. However, three-dimensional view is not possible for a viewer of an image at a position distant from the view position in the image surface lateral direction that makes such position seen from a slanted direction of the lenticular sheet 12 when the center of lens 1 and the center viewpoint are aligned as shown in FIG. 3A. In order to prevent this, as shown in FIG. 3B, if the image is distanced from the view position in the lateral direction, it is necessary to misalign the printing position of the divided image from the corresponding lenses 1 when printing the divided images.

As such, in order to obtain a favorable three-dimensional effect across the entire image surface at a single view position, a print pitch is set that is larger than the lens pitch and printing may be performed so as to match the alignment of the lens pitch and the alignment of the print pitch at the view position (standard position).

Hereinafter, the calculation process for the print position for each divided image are described.

Presumptively, the lenticular sheet 12 used herein has N number of lens 1 in the printing area. Further, although the suitable view position is thought to be different depending on the object and configuration of the multi-viewpoint image, here, the position of the person's face which is the main object is set to be the view position.

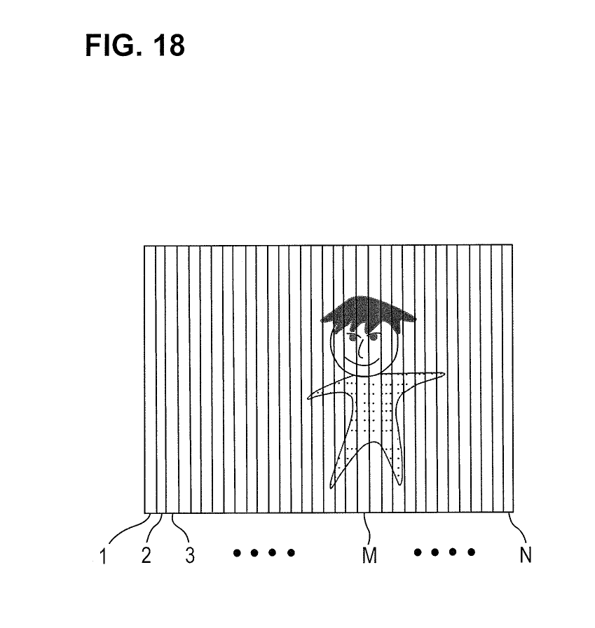

As shown in FIG. 18, N number of striped divided images are generated from each viewpoint image of the input multi-viewpoint image, and the face of the person which is the main object is detected from the image information of the middle viewpoint image (if six viewpoint images, then the third viewpoint image or the fourth viewpoint image) from among each of the viewpoint images. Known face detection technology may be used to detect the face of the person. With the example shown in FIG. 18, the main object exists in the Mth divided image from the left from among the 1st˜Nth divided images.

Accordingly, when printing this multi-viewpoint image to the lenticular sheet 12, the position of the “M”th lens from the left from among each lens 1 of 1˜N of the lenticular sheet 12 may be made to be the standard position (view position) in which the alignment of the lens pitch and the alignment of the printing pitch of the divided image match.

Herein, when the lens pitch of each lens 1 that configures the lenticular sheet 12 is “PL”, the focal length of lens 1 is “f”, and the distance (view distance) between the viewer and the lenticular sheet 12 is “L”, the print pitch “z” of the divided image that corresponds to each lens 1 is formulated as:

z=PL×(1+f/L) Formula 1

Accordingly, the print position displacement amount “δ” between the center of the “n”th lens from the left and the center viewpoint is formulated as:

δ=PL×f/L×(n−M) Formula 2

Herein, the print position misaligns to the left direction of FIG. 18 when δ is negative and when δ is positive it misaligns to the right direction of FIG. 18.

Each divided image is placed in the determined printing position in this manner when printing the images to the lenticular sheet 12. For example, in the event of printing in the order from left to right of the print area, the lens position that is at the leftmost side in relation to the print area of the lenticular sheet 12 will be detected, and the first print position misalignment amount δ from the left is calculated using above formula 2 with “n” substituted as “1”. And then, printing is initiated from the displaced position of only the print position misalignment amount δ in relation to the detected lens position. Thereafter, the subsequent area to the sequential right side may be printed by the print pitch z calculated from the above formula 1.

By printing the images in this manner, images can be printed at the “M”th lens position from the left in which there is a main object with the alignment of the lens pitch and the alignment of the printing pitch of the divided image being matched. Moreover, images can be printed for the other lens positions by suitably misaligning the center of lens 1 and the center viewpoint.

In practice, since the portion of the divided image outside the print area is not printed, when the lens position is detected at the leftmost side in relation to the print area of the lenticular sheet 12, printing may initiate from the divided image that corresponds to the detected lens position.

The lenticular sheet 12 printed in the above-described manner offers a favorable three dimensional print across the entire image surface when viewed over the Mth lens from the left.

Moreover, predetermined values of lens pitch PL are not substituted to formula 1 and formula 2, and substituting a measured value of the actual lens pitch of the lenticular sheet 12 for actual printing are preferred, wherein the measured value is measured via a transparent optical sensor or the like. Measurement of the lens pitch PL is performed for the number of lenses at the end of the lenticular sheet 12, and an average of the measured values may used be used. By using such measured value, printing can be performed at a suitable position even in the presence of manufacturing tolerance or the like, thereby offering a favorable three dimensional print.

Moreover, by measuring the temperature of the periphery of the lenticular sheet 12, the printing position may further be corrected.

Note that, although the position of the person's face of the main object is used as the view position here, the view position can be determined by the configuration of the multi-viewpoint image, or the view position can be the position of the object with the largest parallax.

### [Overall Construction of the Print Device]

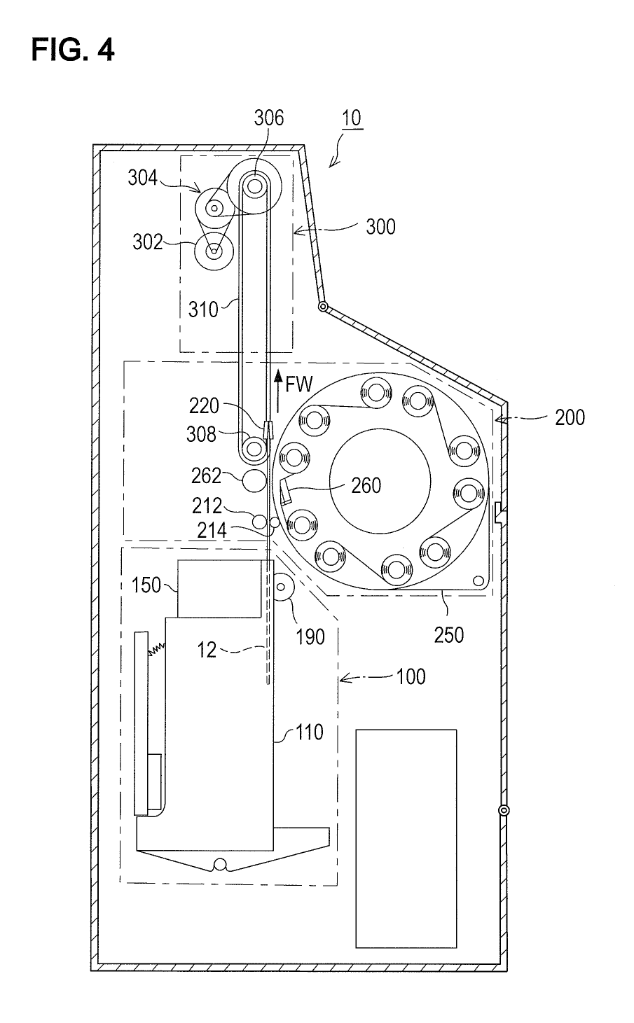

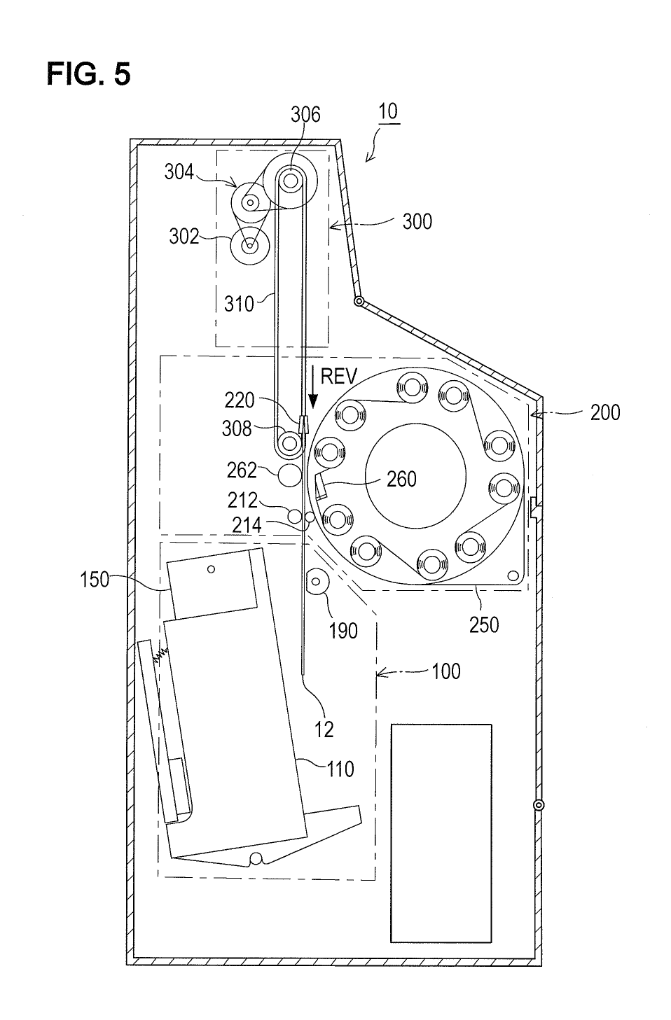

FIG. 4 and FIG. 5 respectively show the internal transparental views schematically representing embodiment of print device according to the present invention. FIG. 4 shows the state of providing of a lenticular sheet from a sheet feed cassette. FIG. 5 shows the state of a sheet return operation after printing.

As shown in FIG. 4 and FIG. 5, the print device 10 is a vertically oriented three dimensional printer that prints by conveying the lenticular sheet 12 in the vertical direction and is mainly configured with a sheet storing part 100, printing part 200, and an air feed part 300.

The print device 10 is a sublimation printer that uses R (receiving layer), Y (yellow), M (magenta), C (cyan), and W (white) ink ribbons and repeats the upward movement (at the time of printing) and downward movement (reverse feed to the print initial position) for each print color, and the conveyor path of the lenticular sheet 12 is configured with a straight path identical with the rise and fall.

### [Sheet Storing Part]

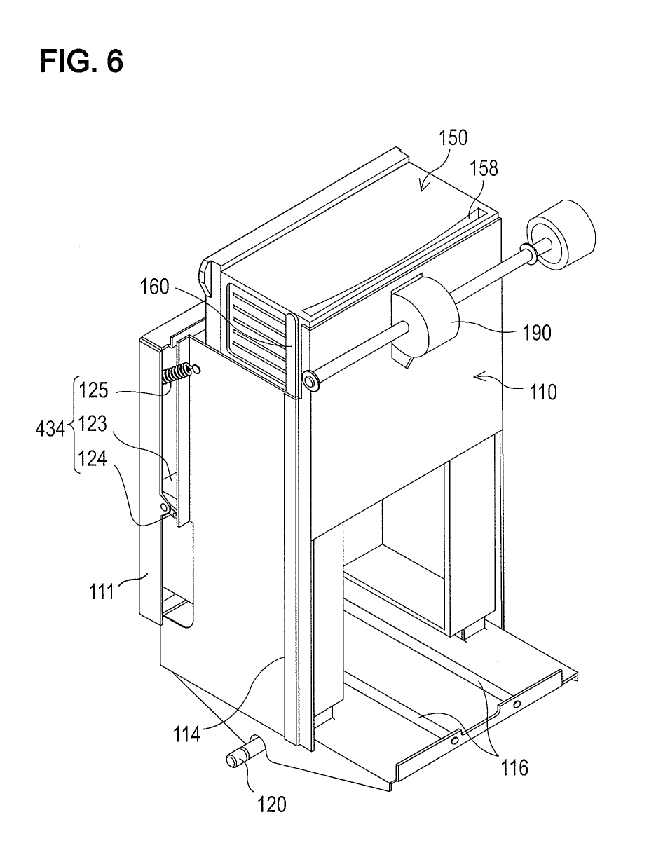

FIG. 6 is a detailed perspective view showing the configuration of a sheet storing part 100.

The sheet storing part 100 is mainly configured with a sheet storing main body 110 and a sheet feed cassette 150. The sheet feed cassette 150 is made with the ability to freely attach and detach to the sheet storing main body 110.

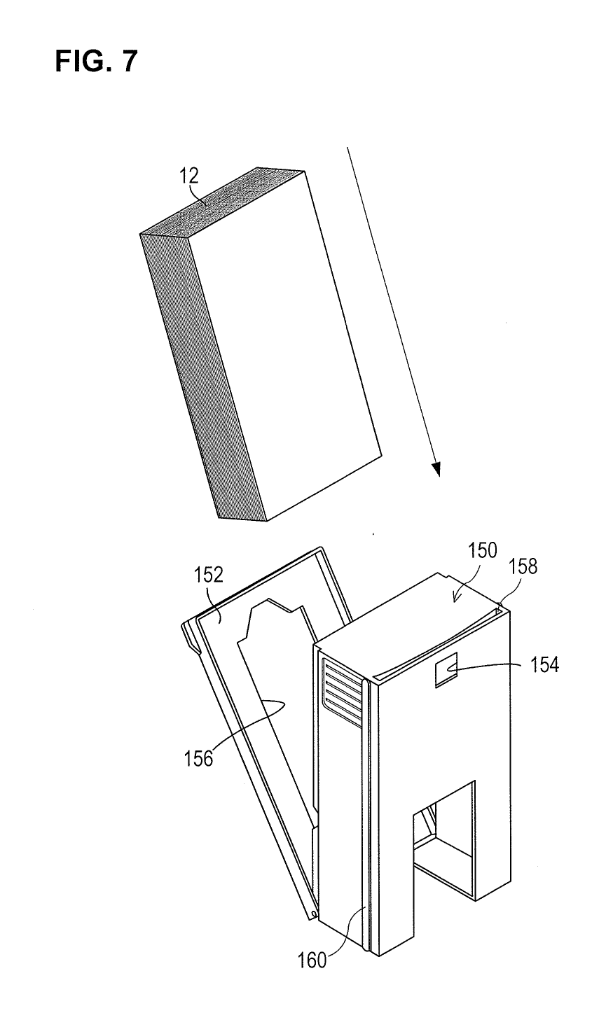

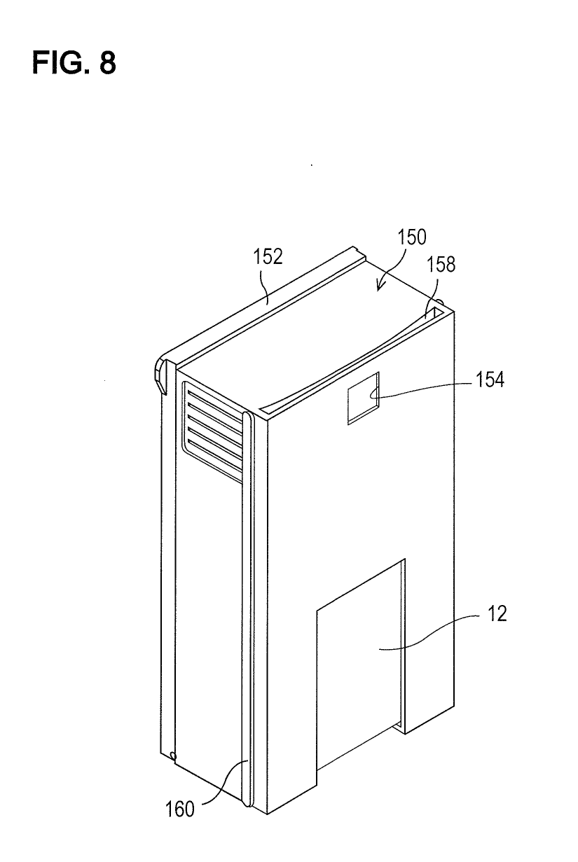

FIGS. 7 and 8 respectively shows perspective view of the sheet feed cassette 150. FIG. 7 shows the status of opening the cassette cover 152 of the sheet feed cassette 150 and then inserting the lenticular sheets 12, with 100 to 200 sheets laminated, into the cassette. The lenticular sheet 12 is inserted so that the surface on which the lenticular lens is formed is on the side that cassette cover 152 is located, and the lens 1 is inserted with the longitudinal direction of the lens 1 being in the perpendicular direction with respect to the insertion direction of the sheet to the cassette. FIG. 8 shows the state of cassette cover 152 being closed after lenticular sheet 12 has been inserted into the cassette.

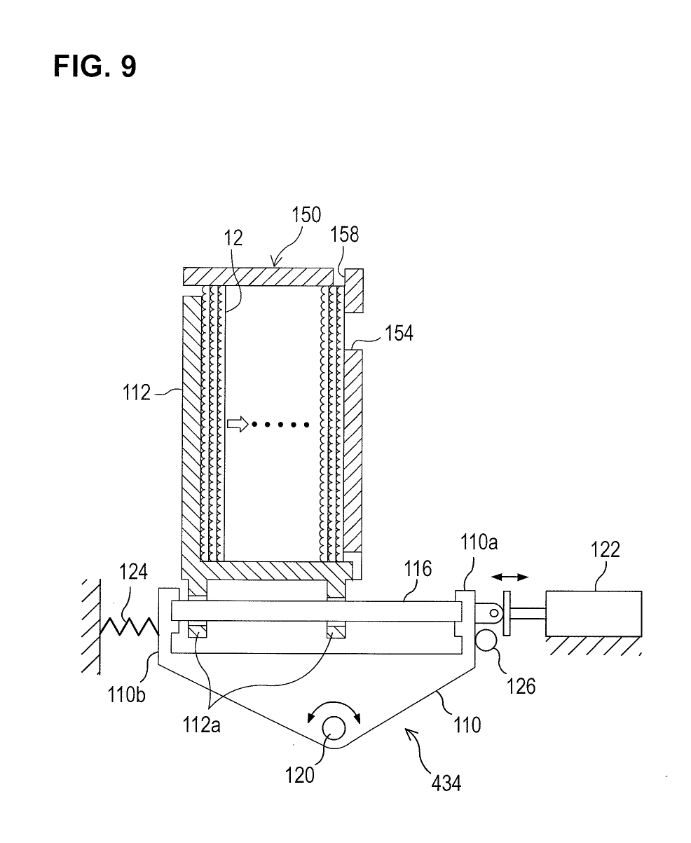

An opening 154 is formed on the front surface of the sheet feed cassette 150 for inserting the feed roller 190 (refer to FIG. 6). Meanwhile, a pressure board opening 156 is formed on the rear surface of the cassette cover 152 for inserting the L-shaped pressure board 112 (refer to FIG. 9).

Further, a discharge port 158 for discharging a one sheet of lenticular sheet 12 from the cassette is formed on the top surface of the sheet feed cassette 150, while a protruding bar 160 is formed on the rear surface of the sheet feed cassette 150 in the vertical direction with respect to the lateral surface of the sheet feed cassette 150. The sheet feed cassette 150 is set in a predetermined position on the sheet storing main body 110 by engaging a protruding bar 160 of the sheet feed cassette 150 to the channel 114 formed on the lateral surface of the sheet storing main body 110.

FIG. 9 is a schematic diagram of the lateral surface of the sheet storing part 100.

When the sheet feed cassette 150 is inserted into the sheet storing main body 110, the lenticular sheet 12 stored within the sheet feed cassette 150 is placed on the L-shaped pressure board 112 at the sheet storing main body 110 side.

The pressure board 112 is supported with a single degree of freedom to the front and rear direction (lateral direction and FIG. 9) by two guide shafts 116 and is configured to move by the pressure board driving mechanism that includes a motor (not shown).

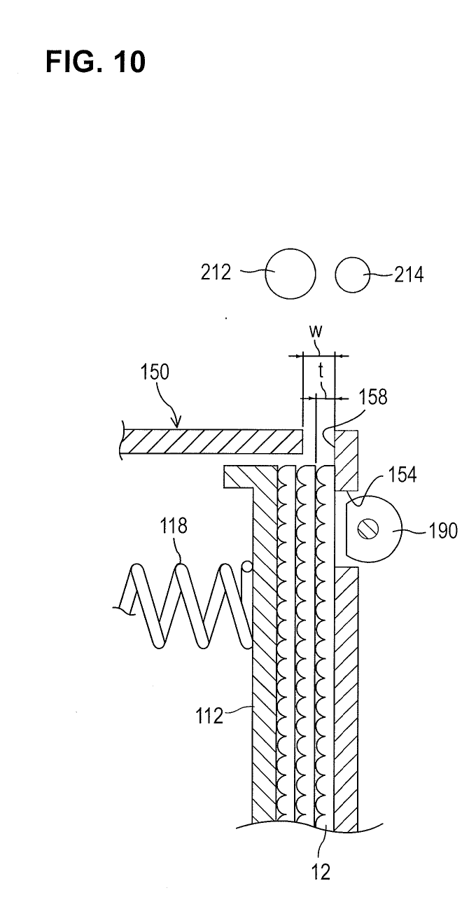

In addition, the pressure board 112, as shown in FIG. 10, applies pressure to the lenticular sheet 12 within the cassette via an elastic member 118, with the position of the pressure board 112 being regulated so as to maintain a constant pressure.

The sheet storing main body 110 is configured with the ability to swing by a cassette retraction mechanism 434 shown in FIG. 9. The cassette retraction mechanism 434 is mainly configured with a plunger 122, a biasing spring 124 and a stopper 126, and the sheet storing main body 110 is provided to be able to swing using the bottom part of rotational axis 120.

As shown in FIG. 4, when feeding the lenticular sheet 12 from the sheet feed cassette 150, the power to the plunger 122 is off. In this way, the sheet storing main body 110 can be pivoted to a position to contact the stopper 126 by the biased force of the biasing spring 124, and the sheet feed cassette 150 stored in the sheet storing main body 110 is held in a vertical position.

Then, when the lenticular sheet 12 is discharged from the sheet feed cassette 150 and the first printing using the ink ribbon is completed, the power to the plunger 122 is turned on. In this manner, the sheet storing main body 110 is pivoted (tilted) against the biased force of the biasing spring 124 in the counter-clockwise direction in FIG. 9.

FIG. 5 shows the tilted position of the sheet storing main body 110 using the plunger 122. Though the lenticular sheet 12 is returned to the print starting position for printing with the next ink ribbon, the lenticular sheet 12 does not interfere with the sheet feed cassette 150 since the sheet storing main body 110 (sheet feed cassette 150) is tilted.

Therefore, in addition to the ability of conveying a lenticular sheet 12 by a straight path from the printing operation of the lenticular sheet 12 through the return operation, shortening of the conveyor path (i.e. downsizing of the device) for the lenticular sheet 12 is also achieved.

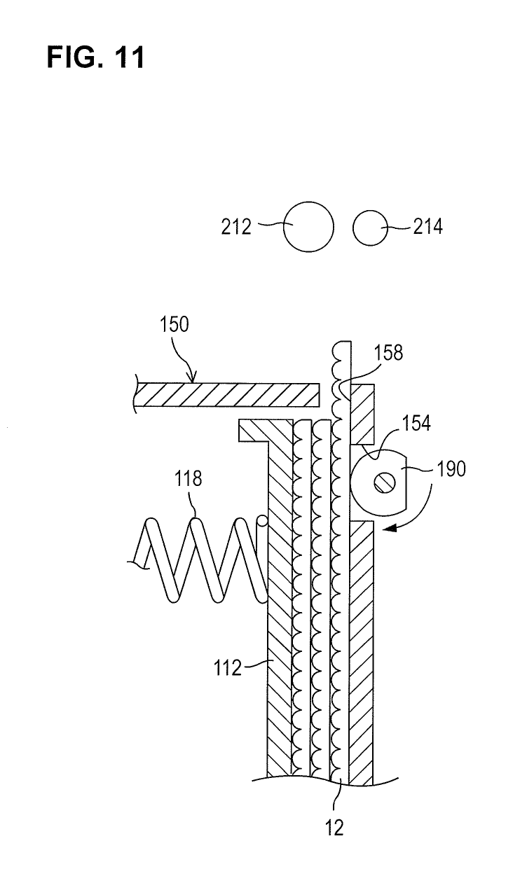

As shown in FIG. 11, when the feed roller 190 is rotationally driven in the feed direction in a state in which the lenticular sheet 12 is pressed, the lenticular sheet 12 in contact with the feed roller 190 moves according to the rotation of the feed roller 190, and the lenticular sheet 12 is sent out from the discharge port 158 of the sheet feed cassette 150. The discharge port 158 is formed so that the width W is wider than the sheet thickness t but narrower than the two-sheet thickness 2t thereby sending out only a single lenticular sheet 12 from the discharge port 158.

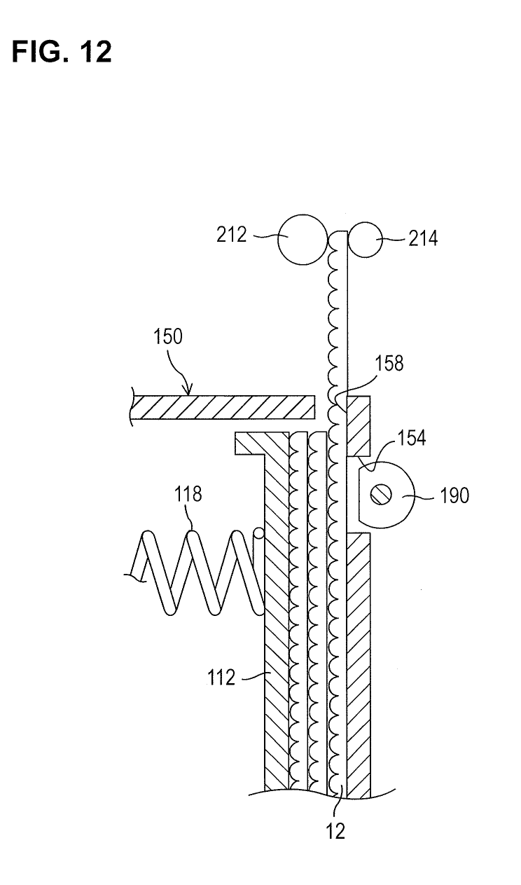

As shown in FIG. 12, when the D cut reaches a position oppositely facing the lenticular sheet 12 upon further rotation by the feed roller 190, rotation is controlled to stop. In this way, the lenticular sheet 12 is sent out only a fixed amount from the sheet feed cassette 150 (for example, until a position in which the edge of the downstream side of the lenticular sheet 12 is held between the conveyor roller 212 and the capstan 214). Further, at the same time, the feed roller 190 will not contact the lenticular sheet 12 (a frictional force from the feed roller 190 is not applied).

### [Printing Part]

As shown in FIG. 4 and FIG. 5, the printing part 200 is mainly configured with a sheet conveyor mechanism that conveys the lenticular sheet 12 at the timing when mainly printing, a ribbon exchange guttering mechanism 250 in which R, Y, M, C, and W ink ribbons are mounted, and, a thermal head 260.

The sheet conveyor mechanism 431 is mainly configured with a feed roller 190, a conveyor roller 212, a capstan 214 and a clamper conveyor part 234 that moves the clamper 220.

The front edge part of the lenticular sheet 12, which is sent out only with a fixed amount from the sheet feed cassette 150 by the feed roller 190, reaches the position of the conveyor roller 212. Herein, the lenticular sheet 12 can be conveyed by the movement of the conveyor roller 212 while the capstan 214 clamps with the lenticular sheet 12 therebetween in relation to the conveyor roller 212.

The conveying of the lenticular sheet 12 by the conveyor roller 212 and the capstan 214 is performed until the front edge of the lenticular sheet 12 reaches the clamper 220 in the lowermost predetermined position which is a standby state. Note that, basically, the clamper 220 is biased constantly in a closing direction by a pair of spring-loaded clamp members, but when in the above-mentioned standby state, the pair of clamp members will stay in an opening position that is against the biasing force of the springs via a cam or the like.

When the front edge of the lenticular sheet 12 reaches the clamper 220, the front edge of the lenticular sheet 12 is clamped by the clamper 220, and the capstan 214 is evacuated from the conveyor roller 212 to a predetermined position. Thereafter, the lenticular sheet 12 is conveyed (moved upward and downward) together with the clamper 220 by the clamper conveyor part 230.

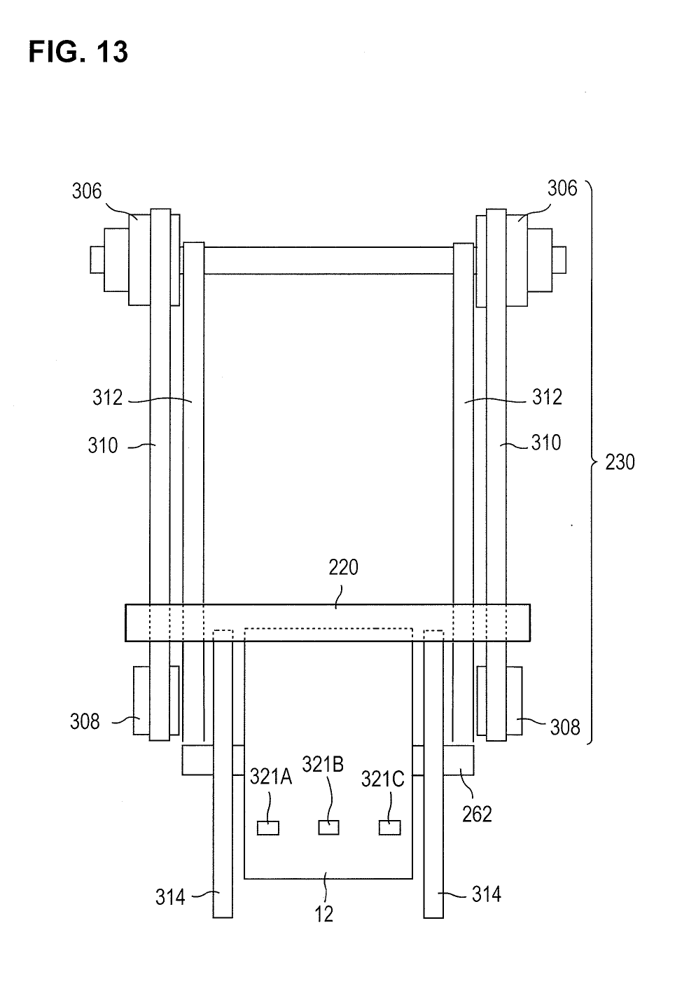

FIG. 13 is a plain view showing the schematic configuration of the clamper 220 and the clamper conveyor part 230.

On the top end of the air feed part 300 shown in FIG. 4, a pair of drive pulleys 306 is provided which drives with respective drive motors 302 via a speed reducing mechanism 304, and a pair of coupled driving pulleys 308 are provided near the platen roller 262.

Drive belts 310 are winded around the drive pulleys 306 and the coupled driving pulleys 308, and the clamper 220 is secured between the drive belts 310 as shown in FIG. 13 with a bolt not shown.

A guide rail 312 is arranged that guides the clamper 220 in a vertical direction along the drive belt 310, and a resin guide 314 is further arranged that guides the lenticular sheet 12 in relation to the clamper 220 that is standing by in the lowermost predetermined position. Note that, the resin guide can be replaced with a rubber guide.

The width of the pair of resin guides 314 is larger than the width of the lenticular sheet 12 only with a predetermined clearance. The resin guide 314 guides so that the lenticular sheet 12 will be arranged along in the vertical direction.

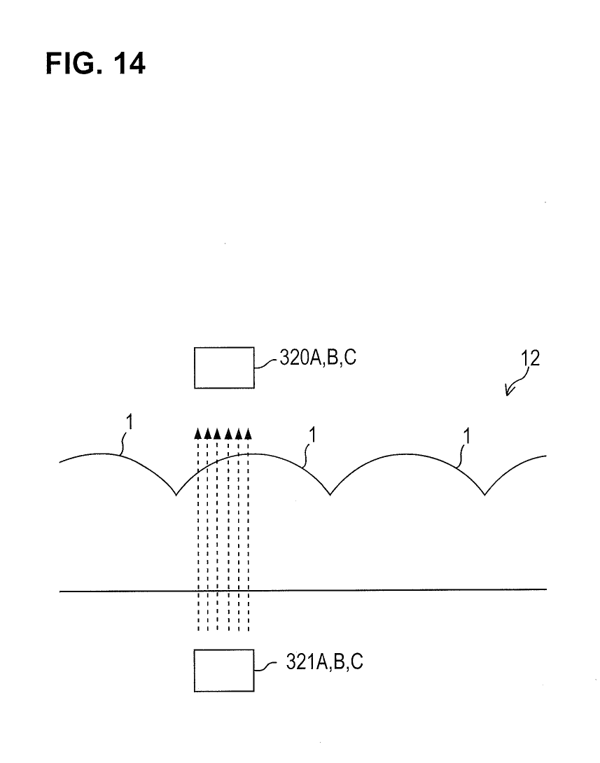

Three photo sensors 320A, 320B and 320C (not shown in FIG. 13) are arranged in parallel with respect to the platen roller 262 on the input side of the platen roller 262. Light emitting diodes (LED) 321A, 321B and 321C are arranged in a position oppositely facing the photo sensors 320A, 320B and 320C with a travel path of the lenticular sheet 12 placed between the diodes and the sensors. The photo sensors 320 and the LEDs 321, as shown in FIG. 14, are configured to be a transmissive optical sensor in which the light irradiated from the respective LEDs 321A, 321B and 321C are received by the photo sensors 320A, 320B, 320C via the lenticular sheet 12 therebetween.

The longitudinal direction of lens 1 formed on the front surface of the lenticular sheet 12 is conveyed nearly parallel with respect to the platen roller 262. Herein, the light amount received by the photo sensors 320A, 320B and 320C is maximized when the center of the LEDs 321A, 321B and 321C matches the center of lenses 1 of the lenticular sheet 12, and minimized when the position is in the valley between adjacent lenses 1. Accordingly, the tilt (azimuth angle) of the lenticular sheet 12 can be detected based on the detection signal of the three photo sensors 320A, 320B and 320C.

The azimuth adjustment (adjustment in which the azimuth angle is 0) of the lenticular sheet 12 is performed by clamping the front edge of the lenticular sheet 12 with the clamper 220, and then slightly tilting the clamper 220 only with the azimuth adjustment amount by independently driving the pair of left and right drive pulleys 306 respectively while monitoring the detection signal of the three photo sensors 320A, 320B and 320C.

After the azimuth adjustment as described above, the lenticular sheet 12 is conveyed to the print initial position by upwardly moving the clamper 220. The print initial position can be detected from, for example, the distance between the photo sensors 320 and the thermal head 260 which is a known distance, and the position which the output signals of the photo sensors 320A, 320B and 320C reaching a predetermined value (for example, the peak value).

Thereafter, printing with the thermal head 260 will initiate. The clamper 220 conveys the lenticular sheet 12 according to the print pitch. When the printing for one color is completed, the clamper 220 is downwardly moved by the reverse movement of the drive pulley 306, and the return operation is performed that returns the lenticular sheet 12 again to the print initial position.

Further, based on the detection signal of the photo sensors 320A, 320B and 320C at the timing of conveying the lenticular sheet 12 by the clamper 220, the lens pitch PL can be detected for lens 1 of the lenticular sheet 12.

Moreover, the arrangement of the photo sensors 320 and LEDs 321 can also be reversed. In other words, the LEDs 321 can be arranged on the lenticular lens surface of the lenticular sheet 12, while the photo sensors 320 are arranged on the print surface side.

### [Ribbon Exchange Guttering Mechanism and Thermal Head]

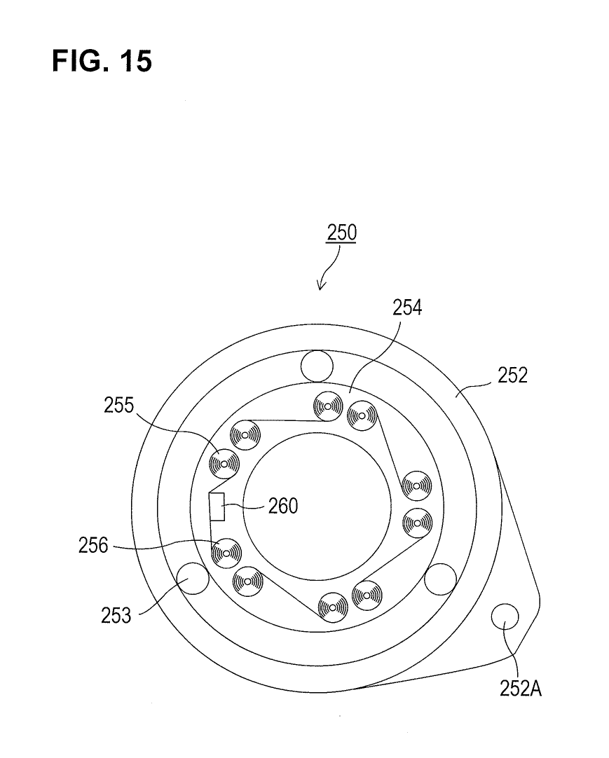

FIG. 15 is a schematic view of the ribbon exchange guttering mechanism 250.

The ribbon exchange guttering mechanism 250, as shown in FIG. 15, has a ribbon cage holder 252 and a ribbon cage 254. The ribbon cage holder 252 is configured so as to swing centrally around the ribbon cage holder swing axis 252A.

The thermal head 260 is provided in the ribbon cage holder 252 and is arranged on the front edge of an arm member (not shown in the drawing), wherein the arm member is arranged so as to pivot freely on the same axis as the ribbon cage holder swing axis 252A With the pivoting movement of the arm member, the thermal head 260 can be moved between the print position and the retracted position.

The ribbon cage holder 252 is arranged to be able to move between the print position and the maintenance position by swinging (pivoting) centrally with the ribbon cage holder swing axis 252A, and in a maintenance position, a portion of the ribbon cage holder 252 may protrude from the device main body.

The thermal head 260 engages and moves to the maintenance position of the ribbon cage holder 252 and moves until a position in which the heat generating element of the thermal head 260 can be touched from the outside. In this way, maintenance such as cleaning and replacement of the thermal head 260 can be performed easily.

Moreover, the ribbon cage 254 is supported to the ribbon cage holder 252 with the ability to freely pivot by the ribbon cage at the bearing 253. Five pairs of take-up reels 255 and feed reels 256 are arranged to the ribbon cage 254 in a equal distance. Respective R, Y, M, C and W ink ribbons are set to the five pairs of reels. The ribbon cage 254 is pivoted so that the desired ribbon can be placed in a position of the thermal head 260 by the guttering mechanism.

The take-up reel 255 from within the pair of take-up reel 255 and feed reel 256 that was moved to the position of the thermal head 260, takes up the ink ribbon through the friction clutch at a speed slightly faster than the movement speed of the lenticular sheet 12 at the time of printing, and a brake is applied to the feed reel 256 so as to apply a predetermined back tension to the ink ribbon. In this way, the ink ribbon can be fed by engaging (synchronizing) with the movement of the lenticular sheet 12.

The thermal head 260 can be moved to the print position to contact with the platen roller 262 with the ink ribbon and lenticular sheet 12 therebetween at the time of printing by the head movement mechanism, and can be moved to the retracted position in which it is retracted from the platen roller 262 at the time of replacing the ink ribbon and reversing of the lenticular sheet 12.

In addition, the thermal head 260 can be driven according to the multi-viewpoint image (the 6 view image of the present embodiment) for use in the three dimensional image to be described hereinafter, and to sublimate ink onto the ink ribbon and print-transfer it to the lenticular sheet 12.

### [Description of the Print Device Control System]

A description will be given hereinafter of the control system for the print device 10 with the above configuration.

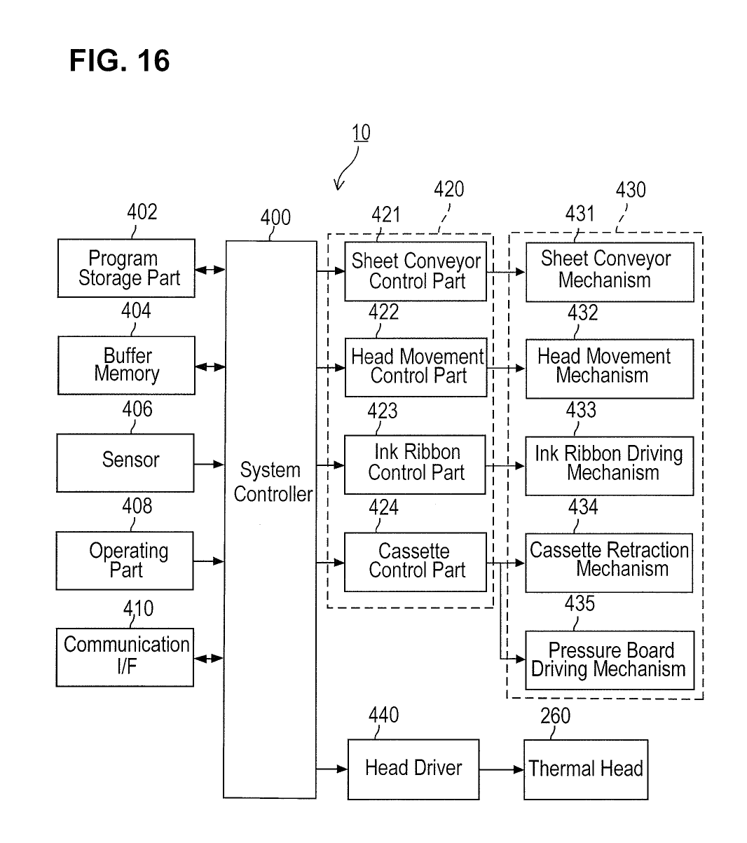

FIG. 16 is a block diagram showing the essential configuration of a print device 10.

The print device 10 is comprises a system controller 400, a program storage part 402, buffer memory 404, sensors 406, operating part 408, a communication interface (communication I/F) 410, a control part 420, a mechanism part 430, a head driver 440 and a thermal head 260.

The system controller 400 is the portion that generally controls each part by a program for three dimensional printing, and may be a CPU (central processing unit) or the like. The program for three dimensional printing is stored in the program storage part 402, and the system controller 400 appropriately reads and executes the program stored in the program storage part 402.

The buffer memory 404 is where the print data is temporally stored that is received from the personal computer (PC), not shown, via the communication I/F 410.

The PC connected to the communication I/F 410 acquires a color 2 viewpoint image (left and right images) in which the same object that was photographed by a three dimensional camera or the like is photographed, and calculates the displacement amount (displacement amount between pixels (amount of parallax)) for each pixel for the characteristic points that match the characteristics from the left and right images. After adjusting the calculated parallax amount for a three dimensional print, a 6 viewpoint image is generated by interpolating the adjusted parallax amount. The PC further performs color conversion of R, G, B of the 6 viewpoint image to Y, M, C, and generates a Y signal, M signal and C signal from the color converted 6 viewpoint image for a single sheet portion of the divided image repeatedly arranged. Included in the signals are the view position information, the recording position information, and the like. The Y signal, M signal, and C signal are stored as print data in the buffer memory 404 via the communication I/F 410 from the PC.

Moreover, the image processing function of the PC may also be integrated within the print device 10.

The sensors 406 include sensors for detecting the position and rotational angle and so forth by the photo sensors 320A-320C and the mechanism part 430 as shown in FIG. 13 and output the respectively detected detection signals to the system controller 400.

The operating part 408 configured with a power switch, a print initiation switch, and switches or the like for setting the print count and so forth. Operation signals by the operating part 408 are input into the system controller 400.

Mechanism 430 comprises the sheet conveyor mechanism 431, the head movement mechanism 432, the ink ribbon driving mechanism 433, the cassette retraction mechanism 434 and the pressure board driving mechanism 435.

The sheet conveyor mechanism 431 comprises the clamper conveyor part 230 (FIG. 13) which includes the feed roller 190, the conveyor roller 212, the capstan 214, the clamper 220, the drive motor 302, and so forth, as shown in FIG. 4 and the like.

The control part 420 is comprised of the sheet conveyor control part 421, the head movement control part 422, the ink ribbon control part 423 and the cassette control part 424.

The system controller 400 outputs the control signals to the respective control part 420 according to the print sequence, and drive controls the mechanism part 430 via the control part 420.

In this manner, the sheet conveyor control part 421 discharges the lenticular sheet 12 from the sheet feed cassette 150 while conveying the lenticular sheet 12 upward or downward when printing.

The head movement mechanism 432 moves the thermal head 260, which is arranged at the tip of the arm part, between the print position that contacts the platen roller 262 and the retracted position, by pivoting the arm part that has the same pivot axis as the ribbon cage holder swing axis 252A as described in FIG. 15. Note that, the retracted position has a small retracted position and a large retracted position in that it can be slightly retracted from the platen roller 262 to move into the small retracted position when protruding the ink head by feeding only the ink ribbon, and it can be moved to the large retracted position that does not interfere with the ink ribbon that is set in the take-up reel 255 and the feed reel 256 when rotating the ribbon cage 254 to exchange the ink ribbon with another color.

The ink ribbon driving mechanism 433 is comprised of a mechanism that rotates the ribbon cage 254 of the ribbon exchange guttering mechanism 250, as shown in FIG. 15, and a reel driving mechanism that drives the five pairs of take-up reels 255 arranged in the ribbon cage 254 and the feed reel 256.

The cassette retraction mechanism 434 provides the plunger 122 and so forth as described in FIG. 9 and swings the sheet storing main body 110 with a command from the system controller 400.

The pressure board driving mechanism 435 moves the pressure board 112 as described in FIG. 10 thereby moving the pressure board 112 by a command from the system controller 400 and is configured to apply a constant pressing force to the lenticular sheet 12 within the cassette.

Plurality of heat generating elements are aligned on the thermal head 260 in an orthogonal direction with respect to the conveying direction of the lenticular sheet 12. The system controller 400 controls the temperature of each heat generating element through the head driver 440 to have a concentration that corresponds with the print data for one line based on the print data stored in the buffer memory 404, and print-transfers to the lenticular sheet 12 by sublimating the ink of the ink ribbon, and then advances the lenticular sheet 12 for a single line amount with the sheet conveyor mechanism 431, and performs heat transfer for each line continuously in the same manner given below.

### [Description of the Operation of the Print Device]

A description of the operation of the print device 10 will be given hereinafter.

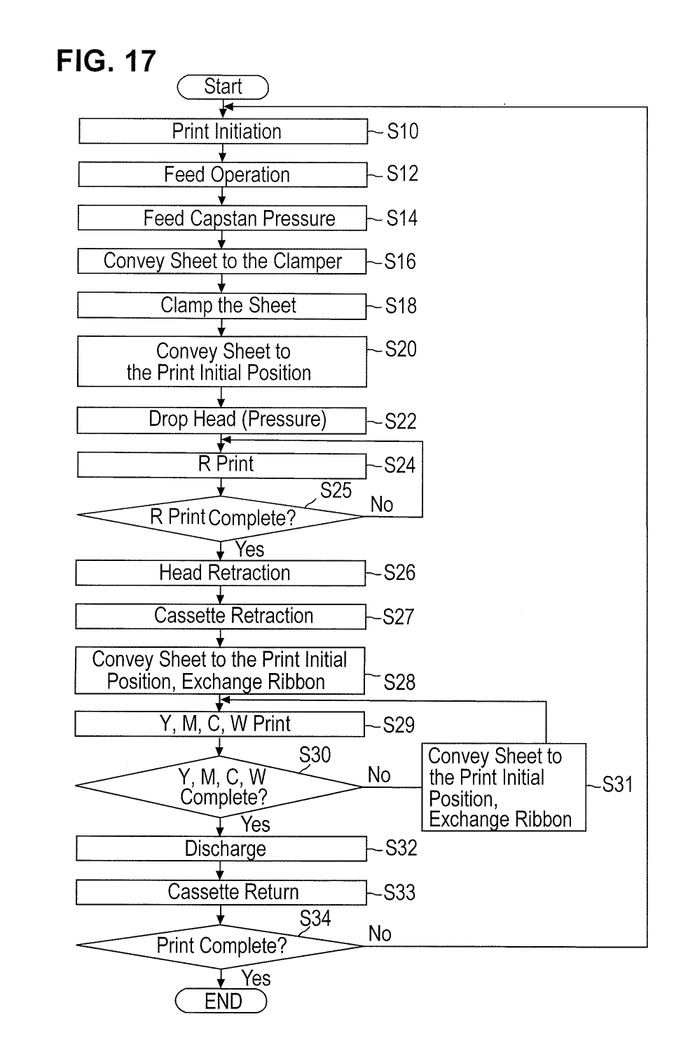

FIG. 17 is a flowchart showing the process operation at the time of printing by the print device 10, and the following will be described according to this flowchart. The print process is controlled by the system controller 400. The program for executing the print process by the system controller 400 is stored in the program storage part 402.

### [Step S10]

After print data for three dimensional printing is stored in the buffer memory 404 via the communication I/F 410 from the PC, printing can be started when turning on the print initiation switch of the operating part 408. Moreover, instructions for print initiation or the like may also be input from the PC which is connected to the communication I/F 410.

### [Step S12]

When print initiation is instructed, the system controller 400 initially rotates the feed roller 190 and sends out the lenticular sheet 12 with only a fixed amount from the sheet feed cassette 110. At the same time, the front edge of the lenticular sheet 12 reaches the conveyor roller 212.

### [Step S14]

The system controller 400 compressively bonds the capstan 214 which is retracted to a predetermined position against the conveyor roller 212 and clamps the lenticular sheet 12 between the conveyor roller 212 and the capstan 214. Note that, a configuration may also be made so that the capstan 214 is compressively bonded to the conveyor roller 212 in advance and the lenticular sheet 12 is inserted between the conveyor roller 212 and the capstan 214 when sending out the lenticular sheet 12 in step S12.

### [Step S16]

Next, the system controller 400 drives the conveyor roller 212 for only a set time and conveys the lenticular sheet 12 to the clamper 220. At the same time, the clamper 220 is standing-by in the lowermost predetermined position, and the conveyor roller 212 is idle when the front edge of the lenticular sheet 12 contacts the clamper 220. Further, by contacting the lenticular sheet 12 with the clamper 220, a rough position determination is performed for the lenticular sheet 12.

### [Step S18]

The system controller 400 drives a cam or the like to close the pair of clamper members by the biasing force of the springs to clamp onto the lenticular sheet 12 with the clamper 220. Further, the capstan 214 compressively bonded to the conveyor roller 212 is retracted to a predetermined position thereby releasing the lenticular sheet from the grip between the conveyor roller 212 and the capstan 214. The azimuth adjustment is performed as described in FIG. 13. Moreover, at the same time, the lens pitch PL may be measured.

### [Step S20]

The system controller 400 drives the clamper conveying part 230 to convey the lenticular sheet 12 which is clamped by the clamper 220 to the print initial position. The print initial position can be made to be a position, for example, in which the output signals of the photo sensors 320A˜320C reach a predetermined value (for example, a peak value) as shown in FIG. 13 after conveying the lenticular sheet 12. In this way, the relative positions of the lens position of the lenticular sheet 12 and the print position of the 6 viewpoint image can be adjusted.

### [Step S22]

The system controller 400 controls the head movement mechanism 432 via the head movement control part 422, and clamps the R ink ribbon and the lenticular sheet 12, and the thermal head 260 compressively contacts the platen roller 262. The conveyor path changes according to the guidance by the capstan 214 so that the ink ribbon fed from the feed reel 256 to the thermal head 260 passes through a position that does not interfere with the light emitting diode 321 arranged in the vicinity of the thermal head 260 regardless of the winding diameter of the ink ribbon of the feed reel 256.

### [Step S24]

The system controller 400 rotates the drive motor 302 via the sheet conveyor control part 421 and drives the clamper 220 according to the print pitch to advance the lenticular sheet 12 in the print direction FW as shown in FIG. 4. Synchronous to this, the ink ribbon driving mechanism 433 reels the ink ribbon with the take-up reel 255 at a speed slightly faster than the movement speed of the lenticular sheet 12 while the thermal head 260 is powered to generate heat to transfer the receiving layer from the R ink ribbon to the lenticular sheet 12.

### [Step S25]

The system controller 400 determines whether the receiving layer formation by the R ink ribbon has completed. For example, the system controller 400 determines this according to whether the lenticular sheet 12 has been sent out a predetermined amount from the print initial position. If “Yes”, it proceeds to S26. If “No”, it returns to S24.

### [Step S26]

The system controller 400, after completing transfer of the receiving layer, controls the head movement mechanism 432 via the head movement control part 422 to move the thermal head 260 to a position that does not interfere with the ink ribbon.

### [Step S27]

The system controller 400 controls the cassette retraction mechanism 434 via the cassette control part 424 to move the sheet storing main body 110 to the retracted position as shown in FIG. 5 and holds the sheet storing main body 110 at the retracted position.

### [Step S28]

The system controller 400 controls the sheet conveyor mechanism 431 via the sheet conveyor control part 421 and initiates moving the lenticular sheet 12 in the reverse direction REV opposite to the print direction FW, i.e. moving from the thermal head 260 side to the sheet storing main body 110 side, then continuously moves until the lenticular sheet 12 reaches the print initial position (head protruding position). Since the sheet storing main body 110 at step S27 is tilted only to a predetermined angle, there is no interference between the lenticular sheet 12 and the sheet feed cassette 150.

The system controller 400 controls the ink ribbon driving mechanism 433 via the ink ribbon controlling part 423 to rotate the ribbon exchange guttering mechanism 250 to the position of the ink ribbon for the color that was first set. Herein, the first color is Y, but it may also be another color. Further, an ink ribbon of a color other than Y may also be adopted.

### [Step S29]

The system controller 400, after pressing the thermal head 260 to the platen roller 262 by sandwiching the lenticular sheet 12 and the exchanged ink ribbon by the head movement mechanism 432, rotates the drive motor 302 and drives the clamper 220 to advance the lenticular sheet 12 in the print direction FW. Synchronous to this, the ink ribbon driving mechanism 433 reels the ink ribbon with the take-up reel 255 at a speed slightly faster than the movement speed of the lenticular sheet 12 while the thermal head 260 is powered to generate heat to transfer the heated color material to the print side of the lenticular sheet 12 from the color ink ribbon thereby forming the image.

Similarly, the ink ribbon fed from the feed reel 256 to the thermal head 260 is guided by the capstan 214 and passes through a position that does not interfere with the light emitting diode 321.

### [Step S30]

The system controller 400 determines whether the transfer of all the colors is complete by the set color ink ribbon. This can be determined in the same manner as step S25. If “Yes”, it proceeds to S32; and if “No”, it proceeds to S31.

### [Step S31]

The system controller 400 controls the sheet conveyor mechanism 431 via the sheet conveyor controlling part 421 to move the lenticular sheet 12 in the reverse direction REV until reaching the print initial position (head protruding position).

The system controller 400 controls the ink ribbon driving mechanism 433 via the ink ribbon controlling part 423 to rotate the ribbon exchange guttering mechanism 250 until the position of the ink ribbon of the next set color. Herein, rotation of the ribbon exchange guttering mechanism 250 is performed in the order of Y, M, C, W, but another order may also be used. After sheet head protrusion and ink ribbon exchange, return to S29 to perform the transfer of color to the print surface of the lenticular sheet 12 by the ink ribbon that is set next. Similarly, printing by the ink ribbon of the set color, determining print completion of the corresponding ink ribbon and head protrusion of the lenticular sheet 12 and the ink ribbon exchange according to the corresponding print determination is performed for the ink ribbons of all the colors.

### [Step S32]

The system controller 400 uses a cutter, not shown, to cut a fixed area of the front and rear edges of the lenticular sheet 12 after printing all the colors, and the print operation is completed by discharging the lenticular sheet 12 by the discharge mechanism not shown. The discharge mechanism is discretionary.

### [Step S33]

The system controller 400 controls the cassette retraction mechanism via the cassette controlling part 424 and holds the sheet feed cassette 150, stored in the sheet storing main unit 110, in a vertical position.

### [Step S34]

The system controller 400 determines whether the printing for all the sheets has completed. If “Yes”, the present process completes. If “No”, the process returns to S10 and initiates the feed of the next sheet.

According to a print device 10 configured in this manner, a three dimensional print with a favorable three-dimensional effect across the whole area of an image surface at a determined view position can be obtained.

1. An image recording device such that divided images of each viewpoint generated from multi-viewpoint images are sequentially arranged correspondingly to each lens of a lenticular sheet and the multi-viewpoint images are recorded to a recording medium to enable three-dimensional view through the lenticular sheet, wherein the device comprising:
a printing pitch calculating part that calculates a printing pitch of the divided image based on the lens pitch of the lenticular sheet;
a standard position determining part that determines a standard position by matching the lens pitch alignment and the printing pitch alignment based on an image information of the multi-viewpoint image;
a recording position determining part that determines a recording position of each divided image based on the standard position and the printing pitch; and
a recording part that records each divided image to the recording position.

2. The image recording device according to claim 1, wherein the printing pitch calculating part calculates the printing pitch based on a focal length of the lens of the lenticular sheet and a preset three-dimensional vision viewing distance.

3. The image recording device according to claim 1, wherein a part for detecting the lens pitch of the lenticular sheet is provided.

4. The image recording device according to claim 1, wherein
the recording part comprises,
a recording head that records an image to the recording medium, and
a conveyor part that relatively moves the recording head and the recording medium; and
the conveyor part relatively moves the recording head and the recording medium according to the recording position.

5. The image recording device according to claim 1, wherein
a main object detecting part that detects a main object of the multi-viewpoint image is provided, and
the standard position determining part determines the standard position based on the position of the main object.

6. The image recording device according to claim 5, wherein the main object detecting part detects a person within the multi-viewpoint image as the main object.

7. The image recording device according to claim 6, wherein the main object detecting part detects the face of the person within the multi-viewpoint image as the main object.

8. The image recording device according to claim 5, wherein the main object detecting part detects the object having large parallax in the multi-viewpoint image as the main object.

9. The image recording device according to claim 5, wherein the main object detecting part detects the main object according to the composition of the multi-viewpoint image.

10. An image processing device such that a divided image of each viewpoint generated from a multi-viewpoint images are sequentially arranged correspondingly to each lens of a lenticular sheet, wherein the device comprising:
a printing pitch calculating part that calculates a printing pitch of the divided image based on the lens pitch of the lenticular sheet;
a standard position determining part that determines a standard position by matching the lens pitch alignment and the printing pitch alignment based on an image information of the multi-viewpoint image;
a recording position determining part that determines a recording position of each divided image based on the standard position and the printing pitch; and
an output part that outputs the recording position.
